(19) United States
(12) Patent Application Publication
(10) Pub. No.: US 2009/0002644 A1
(43) Pub. Date: Jan. 1, 2009

(54) INVISIBLE SCANNING SAFETY SYSTEM

(75) Inventors: Robert R. Christensen, Rapid City, SD (US); Bret D. Winkler, South Jordan, UT (US); Allen H. Tanner, Sandy, UT (US); Jeffery J. Waite, Salt Lake City, UT (US); Dennis F. Elkins, Draper, UT (US); Michael J. McMahon, Sandy, UT (US); Forrest L. Williams, Sandy, UT (US)

Correspondence Address: GRANT R CLAYTON;CLAYTON HOWARTH & CANNON, PC, P O BOX 1909, SANDY, UT, 84091-1909, US

(73) Assignee: EVANS & SUTHERLAND COMPUTER CORPORATION, Salt Lake City, UT (US)

(21) Appl. No.: 12/124,956

(22) Filed: May 21, 2008

Related U.S. Application Data
(60) Provisional application No. 60/931,321, filed on May 21, 2007.

(51) Int. Cl. F16P 3/14; G03B 21/14

(52) U.S. Cl. 353/85; 250/559.4

(57) ABSTRACT

An invisible scanning safety system for use with laser projection systems that includes sensors monitoring less than the entire laser accessible region such that the region monitored is reduced to almost the absolute minimum, to thereby prevent unwarranted stoppages or disturbances in projection. The system may also monitor a 360 degree region around the lens of the laser projector, a wedge-shaped region, a pyramid-shaped region or a chimney-shaped region.

### CROSS-REFERENCE TO RELATED APPLICATIONS

This application claims the benefit of U.S. Provisional Application No. 60/931,321, filed May 21, 2007, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Field of the Invention

The present disclosure relates generally to safety systems for use with laser-based projection systems.

2. Description of Background Art

Lasers produce coherent light which, when looked at, appears to the eye to have come from a very distant source. Consequently, the image formed on the retina by a laser beam is always incredibly small and therefore of very high power density. Most lasers that are used in entertainment, theater and public exhibitions have outputs high enough to pose a significant risk of eye injury. If the laser output power is greater than about 0.5 watts, burning a person's skin may also be a significant risk. Laser powers of just a few milliwatts can damage the retina long before natural aversion responses such as blinking can take place. By contrast, a non-coherent source of radiation, such as a light bulb, is less hazardous to view because it forms an extended image, rather than a point image, when focused by the eye. The power density of non-coherent light at the retina is therefore lower than that produced by a laser of equivalent radiant power.

Eye-injury thresholds depend upon a number of factors such as wavelength, exposure duration and viewing situation. Injury severity following overexposure depends upon the part of the retina that is overexposed and the extent of any bleeding within the eye. Effects range from partial blindness to total loss of sight in the affected eye. Eye damage caused by exposure to laser radiation is generally permanent.

As image projection systems advance, the desire for a higher lumen output grows. Higher output systems are especially desirable when large surfaces are being projected upon, such as in dome-style theaters. The greater the number of lumens produced by a projection system, the greater the contrast ratio that can be produced (contrast is a measure of a system's darkest and brightest levels). Thus, higher lumen output systems inherently increase the potential for eye damage to human beings.

To reduce the risk of potential injury, often times barriers of some sort are put into place to limit human interaction with the projected light. Such barriers may include walls, railings, or other physical means to inhibit the public from placing themselves in danger. Non-physical barriers may also be used, and usually include invisible scanning systems that are attached to domes, walls, and other fixed stands.

The available scanning systems may include one or more sensors for receiving a stimulus from a monitored region. The stimulus may include reflected light beams from light that is directed into the monitored region. When a human or other foreign object crosses into a monitored region, the projection system may automatically switch to a safe mode of operation before any potential harm can occur.

The proposed new system and method of this application combines an scanning safety system with an image projection system and has particular use with image projection systems utilizing lasers which are powerful enough to cause damage to the human visual anatomy. The scanning safety system is relatively imperceptible to the vision of human beings and in most applications will be invisible to the vision and other senses of human beings. Thus, the new system and method may form an invisible barrier over the most critical areas of a laser projection system so there is no need for an external barrier or any additional safety components to prevent harmful human interaction with the laser light being projected.

The unobtrusive, and in most applications invisible, barrier of the present system and method may extend along an outermost boundary of a laser accessible region for the laser projection system. The barrier may also take the form of a wedge shape, pyramid shape or a chimney shape. Again, according to one aspect of the present disclosure, if the unobtrusive barrier is crossed by a foreign object, the laser projection system will automatically shut off, reduce laser power to a safe level, or blank out the area where the foreign object is located, all preventing harm to the foreign object such as a human being.

Another proposed feature of the present system and method is that it can exist with several warning layers that can initiate a temporary reduction in power and/or an audible warning as part of an additional safety zone if a foreign object comes near a location where action will be taken regarding the power of the projected laser light, that is the actual cut off point.

The present system and method is particularly suited for use with laser projection systems such as the Evans & Sutherland Laser Projector (“ESLP”) which incorporate coherent light sources with Grating Light Valve™ (“GLV”) light modulators. GLV based systems work by scanning a narrow column of pixels across a screen using a column-based architecture. The amount of concentrated light in the narrow width can potentially be dangerous if scanned across a human eye at a close distance, however, the column-based architecture is inherently safer at larger distances than raster-based architecture using a beam in which all of the beam's energy is focused onto a single point. But, the distances for potential damage still vary with intensity and size of the original source even for laser projection systems with column-based architectures.

In view of the dangers posed from laser radiation, industry guidelines and governmental regulations dictate safety rules to prevent injury to the public. Furthermore, many previously available devices have been developed to prevent accidental exposure to laser radiation all of which have problems and disadvantages addressed by the system and method of the present disclosure.

The features and advantages of the disclosure will be set forth in the description which follows, and in part will be apparent from the description, or may be learned by the practice of this disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a perspective view of a laser projector with scanners;

FIG. 2 is a view of the laser projector shown in FIG. 1 and the region accessible by the projection lasers;

FIG. 3 is a view of the laser projector shown in FIG. 1 with the region accessible by the projection lasers and a monitored region of one of the scanners;

FIG. 4 is a view of the laser projector shown in FIG. 1 and the full monitoring range of one of the scanners;

FIG. 5 is a view of the laser projector shown in FIG. 1 and an unobtrusive safety barrier;

FIG. 6 is a block diagram of a laser safety system in accordance with an embodiment of the present disclosure;

FIG. 7 is a perspective view of a laser projector with a wedge-shaped invisible safety barrier;

FIGS. 8A-8C are a front view, side view, and a top view, respectively, of the laser projector and the wedge-shaped safety barrier shown in FIG. 7;

FIG. 9 is a side view of the laser projector and the wedge-shaped safety barrier shown in FIG. 7 in relation to a projection cone;

FIG. 10 is a front view of the laser projector and the wedge-shaped safety barrier shown in FIG. 7 in relation to a projection cone;

FIG. 11 is a perspective view of a laser projector and a chimney-shaped safety barrier;

FIG. 12 is a front view of the laser projector and the chimney-shaped safety barrier shown in FIG. 11 in relation to a projection cone;

FIG. 13 is a side view of the laser projector and the chimney-shaped safety barrier shown in FIG. 11 in relation to a projection cone; and

FIG. 14 is a view of the laser projector shown in FIG. 11 and the full scanning range of the scanners.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

In describing and claiming the present disclosure, the following terminology will be used in accordance with the definitions set out below. As used herein, the terms “comprising,” “including,” “containing,” “characterized by,” and grammatical equivalents thereof are inclusive or open-ended terms that do not exclude additional, unrecited elements or method steps.

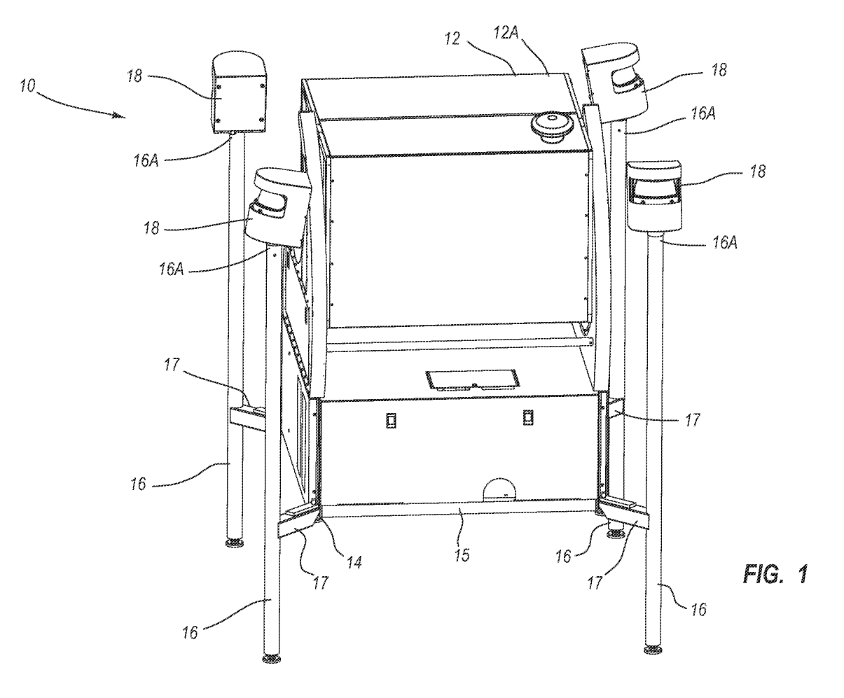

Referring now to FIG. 1, there is illustrated a perspective view of a laser projector 10. The projector 10 includes a boxed enclosure 12 which contains the laser projection components. These components may include one or more light modulation devices, lasers, scanning mirror, power supply, optics, and control circuitry. The lasers and light modulation devices may be under the control of a control unit. The control unit may be able to control the laser output as well as the intensity of the light exiting the projector 10.

The laser projector 10 shown in FIG. 1 is suitable for use in dome-style theaters. The laser projector 10 is mounted on the floor (or ground) at approximately the middle of the dome. The laser projector 10 projects upwardly, to thereby generate an image on the inner surface of the dome.

The enclosure 12 is mounted on a frame 14 having four (4) legs 16. The enclosure 12 serves as a housing for the components of the projector 10. In particular, the enclosure 12 sits on a horizontal platform 15 that is secured to sidewalls of the legs 16 by a plurality of horizontal members 17. In particular, the horizontal members 17 are attached to the lower portions of the legs 16. The legs 16 continue extending vertically upwards from the points where the horizontal members 17 are attached. A top end 16A of each of the legs 16 terminates at approximately the same height as the top 12A of the enclosure 12.

Mounted on the top end 16A of each of the legs 16 is an infrared (“IR”) scanner 18. Each of the IR scanners 18 may include a sensor that receives a stimulus from an area proximate the projector 10. The sensor may be an optical sensor that detects a light stimulus. The IR scanners 18 may further include a laser that sends out a very short pulse of light. At the same time the light is sent out by one of the IR scanners 18, an electronic timer internal to the IR scanner 18 is started. When pulsed light from the IR scanner 18 is incident on an object, it is reflected and received back at the sensor in the IR scanner 18. By measuring the time (Δt) between the transmission of the light pulse and its reception by the sensor, an IR scanner 18 may calculate the distance to the detected object.

The IR scanners 18 may each include a rotating scanning mirror that deflects light pulses from its laser such that the IR scanner 18 may potentially monitor an arc of approximately 190 degrees. An IR scanner 18 may not only determine the distance to an object, but the direction of the object relative to the IR scanner 18 may be determined from the angle of the scanning mirror at which the light pulse was initially transmitted. Thus, from the measured distance and the direction of the object, an IR scanner 18 may determine the exact position of the object relative to the IR scanner 18.

The IR scanners 18 may each include an input/output module for receiving necessary programming. It should be further understood that the laser radiation emitted by the IR scanners 18 is harmless to a person. Desirably, the radiation emitted by the IR scanners 18 is relatively imperceptible by a human and in most instances will be completely invisible to a human. Thus, the system and method of the present disclosure will, in nearly all instances, provide its advantages in an invisible and imperceptible manner to humans. It will be appreciated that many different devices and portions of the electromagnetic or acoustic spectrum can be used to perform the same and equivalent functions carried out by the IR scanners 18.

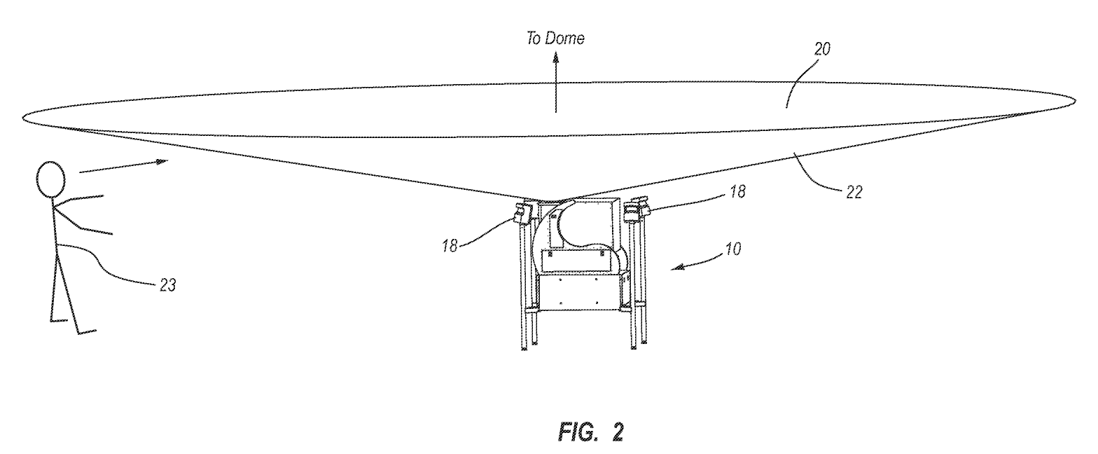

Referring now to FIG. 2, there is illustrated a side view of the laser projector 10. A laser accessible region 20 is depicted in FIG. 2 as the inverted cone extending upwardly from the projector 10, or more specifically, from a projection lens. It will be understood that the laser accessible region 20 is that region through which the laser projector 10 scans or sweeps light from the projection lasers to thereby generate an image on a dome (not explicitly shown). The laser accessible region 20 includes a boundary 22, which are the sidewalls of the inverted cone. The boundary 22 defines where the laser accessible region 20 terminates.

Because the laser projector 10 is typically mounted on the floor, the ground, or on a small pedestal, in the center of a theater, a person 23 may be able to intrude past the boundary 22 and enter into the laser accessible region 20. For example, a person 23 may climb a barrier or stand on a theater seat. Such an intrusion into the laser accessible region 20 would be undesirable because of the potential harm from the laser radiation emitted from the laser projector 10. As will be explained in further detail below, the IR scanners 18 are operable to detect a person 23 before the person 23 crosses the boundary 22 into the laser accessible region 20. Once detected, the projector 10 may automatically employ safety measures to ensure that the person 23 is not harmed by the projection lasers.

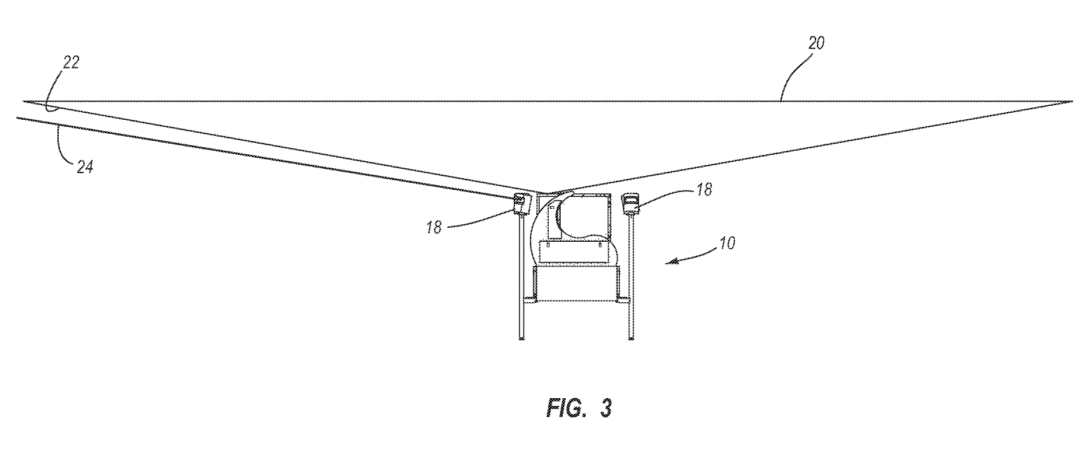

Referring now to FIG. 3, there is depicted a side view of the laser projector 10 and the laser accessible region 20. In addition, there is shown a side view of a monitored region 24 for one of the IR scanners 18. The monitored region 24 from the IR scanner 18 is spaced apart from the boundary 22 of the laser accessible region 20 to thereby provide advanced warning of an intrusion. In this regard, the monitored region 24 shown in FIG. 3 forms part of an unobtrusive, and in nearly all practical applications invisible, barrier. Typically, the spacing between the monitored region 24 and the boundary 22 of the laser accessible region should be adequate to allow the laser projector 10 to switch to a safe operating mode prior to the actual intrusion of the boundary 22 by an object or person 23.

In one exemplary embodiment, the spatial distance between the monitored region 24 and the boundary 22 of the laser accessible region 20 is in the range from about 5 inches to about 18 inches. In another exemplary embodiment, the spatial distance between the monitored region 24 and the boundary 22 of the laser accessible region 20 is about 7 inches. It will be appreciated that the above discussion regarding a single IR scanner 18 is applicable to all four (4) IR scanners 18 of the projector 10.

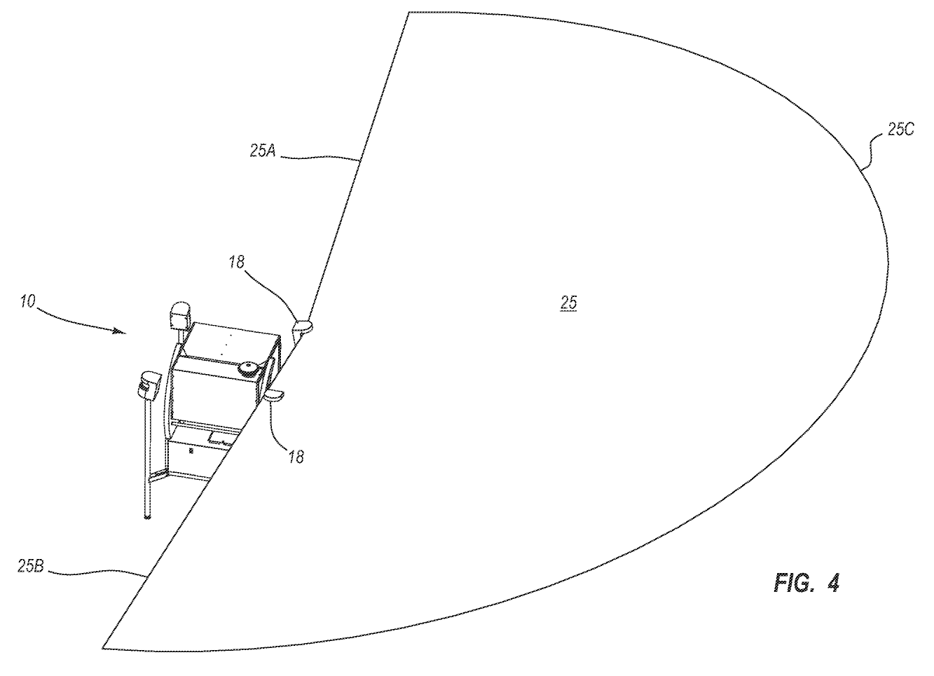

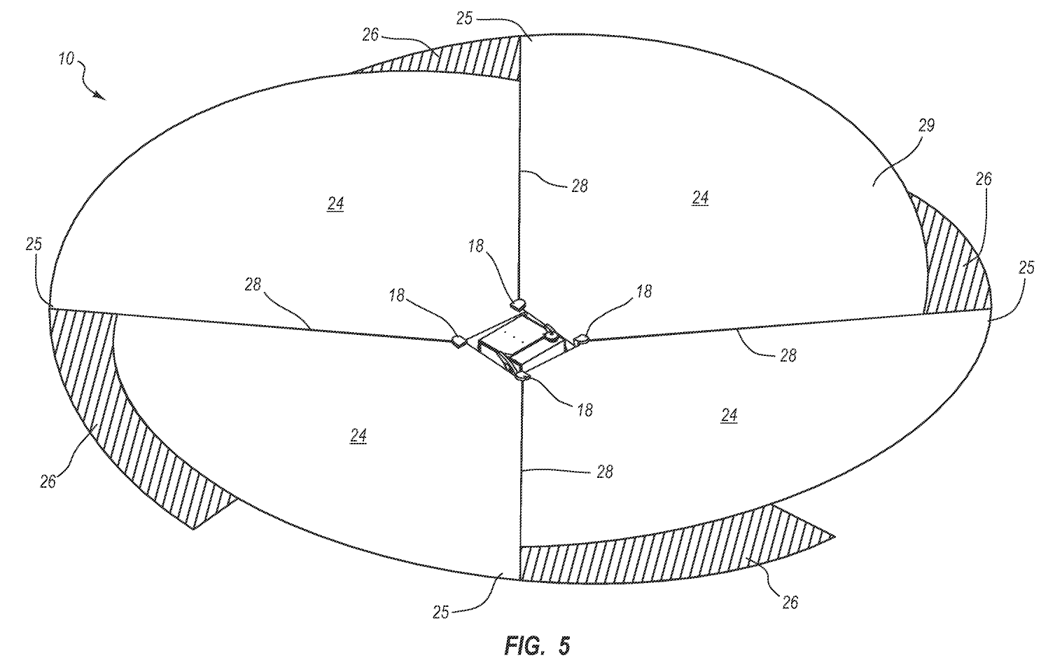

Referring now to FIG. 4, there is depicted a view of the laser projector 10 and the full monitoring range 25 of one of the IR scanners 18. As explained previously, the monitored region 24 (FIG. 5) of an IR scanner 18 represents an area swept by an IR laser internal to the IR scanner 18 using a scanning mirror. The monitored region 24 (FIG. 5) of an IR scanner 18 may comprise only a portion of the full monitoring range 25 of the IR scanner 18.

Still referring to FIG. 4, the full monitoring range 25 of the IR scanner 18 may be substantially planar and include boundaries 25A, 25B and 25C. The boundaries 25A and 25B represent the left and right scanning limits of the IR scanner 18. The boundary 25C is arcuate and may be determined by the maximum scanning distance of the IR scanner 18. However, as will be shown in relation to FIG. 5, it may be undesirable to use the full monitoring range 25 of the IR scanners 18.

Referring now to FIG. 5, there is depicted all four (4) IR scanners 18 and the laser projector 10. The monitored regions 24 of each of the IR scanners 18 intersect along lines 28. The cross-hatched regions 26, while within the full monitoring range 25 of the IR scanners 18, are not monitored for foreign objects. That is, the IR scanners 18 are programmed or otherwise configured not to monitor the cross-hatched regions 26. Alternatively, the IR scanners 18 are programmed to ignore foreign objects in the cross-hatched regions 26.

As seen in FIG. 5, the combined monitored regions 24 of each of the four (4) IR scanners 18 form a continuous invisible barrier 29 adjacent the boundary 22 of the laser accessible region 20 (not explicitly shown in FIG. 5 for convenience purposes). Thus, as best represented in FIG. 2, it is very unlikely, and perhaps virtually impossible, for a person 23 to penetrate into the laser accessible region 20 without detection because of the contiguous barrier 29 formed by the IR scanners 18.

Referring now to both FIGS. 2 and 5, in the event that a person 23 or other foreign object is detected to enter any one of the monitored regions 24, the IR scanner 18 that detects the intrusion will transmit a signal to the projector 10. This detection will occur due to reflected light from the IR laser in the IR scanners 18 stimulating the sensors in the IR scanners 18. The IR scanners 18 may calculate the exact position of the intruding object by angle and distance, or the IR scanners 18 may simply recognize that an intrusion has occurred. In response to the intrusion, the applicable IR scanners 18 will transmit a signal, such as a warning signal, to the laser projector 10. This signal may contain position information on the foreign object. Multiple signals may be sent in order to keep the laser projector 10 updated as to the position of the foreign object.

In response to the signal, the laser projector 10 may automatically switch to a safe operating mode. In one exemplary embodiment, the safe operating mode involves the laser projector 10 to cease projecting an image such that no laser light is emitted from the laser projector 10. In another exemplary embodiment, the safe operating mode involves the laser projector 10 blanking out an area surrounding the intruding object. This is possible because the IR scanners 18 are able to report the location of the foreign object as well as changes in the position of the foreign object. In still another exemplary embodiment, the safe operating mode involves the laser projector 10 reducing the power of the projection lasers such that their laser radiation is at a safe level for incidence upon a human. This may be a localized reduction in power around the intruding object. Alternatively, the laser projector 10 may use the light modulating device to vary the intensity.

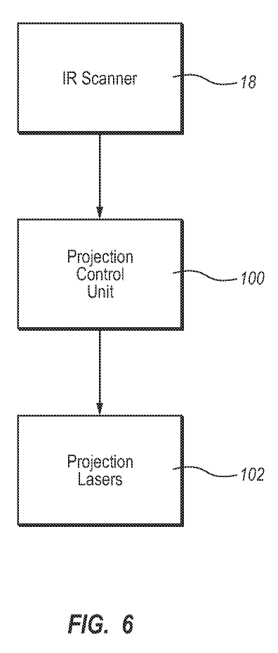

Referring now to FIG. 6, there is depicted a block diagram of a safety system in accordance with an exemplary embodiment of the present disclosure. An IR scanner 18 includes at least one sensor and at least one IR laser. The at least one sensor is able to monitor a monitored region for intrusions. This region may encompass any of the monitored regions described herein.

In particular, the IR scanner 18 receives a stimulus, e.g., a reflected beam of IR light, when an object, such as a person, enters the monitored region. The IR scanner 18 generates a warning signal in response to the stimulus received from the region monitored by the at least one sensor when a foreign object is detected. The warning signal is sent to, and received by, the projector control unit 100. The projector control unit 100 then controls the projection lasers 102, or other appropriate device, to render the projection lasers 62 to an appropriate safe level. It will be appreciated that the system described in FIG. 6 may be utilized with any of the embodiments described herein.

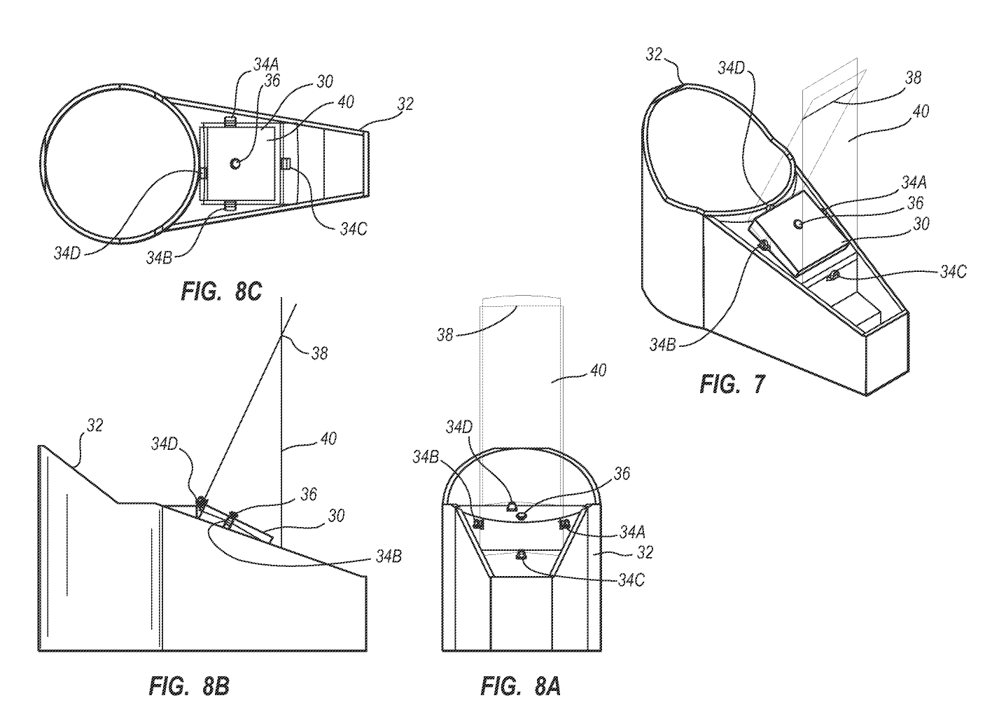

Referring now to FIG. 7, there is depicted another exemplary embodiment of the present invention. A laser projector 30 is mounted in an enclosure 32. It will be noted that the particular shape of the enclosure 32 illustrated in FIG. 7 and FIGS. 8A-C is not crucial and the particular shape of the enclosure 32 shown in these figures may be adapted for a particular installation and the shape of the enclosure may vary to meet the requirements of any specific installation.

Continuing to refer to FIG. 7, four (4) IR scanners 34A, 34B, 34C and 34D are mounted to the enclosure 32 and around a projection lens 36 of the laser projector 30. In a particular, the IR scanners 34A, 34B, 34C and 34D are mounted in a box configuration around the projection lens 36. Stated another way, an IR scanner is located above, below and on either side of the projection lens 36 of the projector 30. Stated still another way, the IR scanners 34A, 34B, 34C and 34D are mounted proximate the projection lens 36.

The IR scanners 34A and 34B monitor planar and predefined regions that extend upwardly from the enclosure 32 and that are substantially parallel to each other. The IR scanners 34C and 34D monitor planar and predefined regions that extend upwardly from the enclosure 32 and that are non-parallel to each other. The predefined regions monitored by IR scanners 34C and 34D intersect along an intersection 38 above the lens 36.

FIGS. 8A, 8B and 8C each illustrate different views of the system shown in FIG. 7, where like reference numerals indicate like components. It will be noted that the predefined monitored regions of the IR scanners 34A, 34B, 34C and 34D form roughly a wedge-shaped or triangularly-shaped invisible safety barrier 40 around an area in front of the projection lens 36. The invisible barrier 40 has two substantially parallel and planar monitored regions and two planar monitored regions, which converge above the projection lens 36.

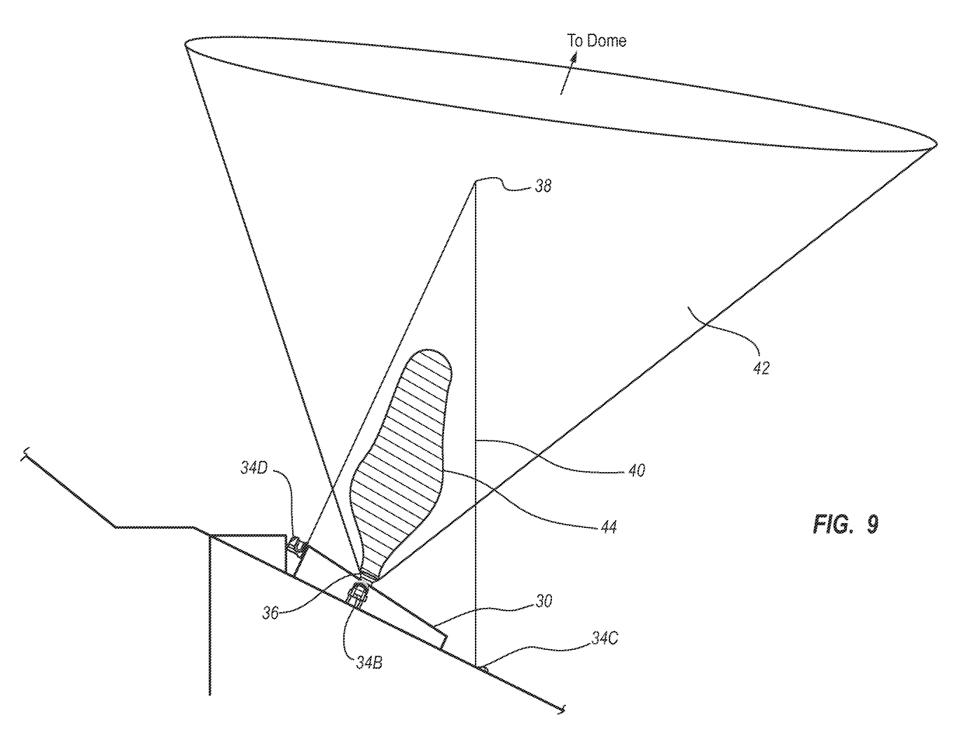

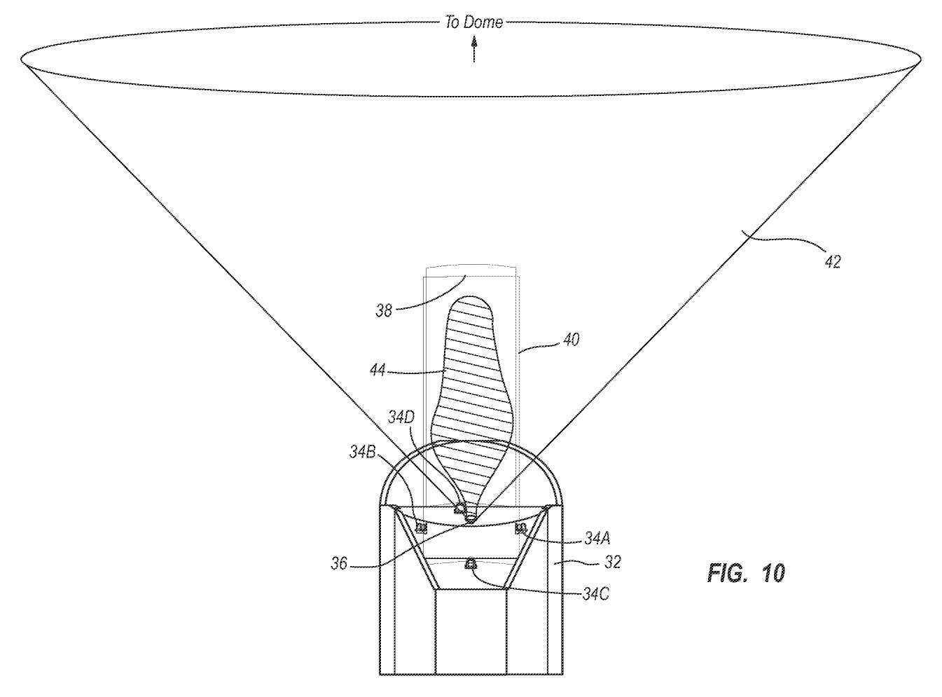

Referring now to FIGS. 9 and 10, where like reference numerals depict like components, a projection cone 42 from the lens 36 is shown in relation to the safety barrier 40. In particular, the predefined monitored regions of the four (4) IR scanners 34A, 34B, 34C and 34D surround the harmful region 44, indicated by the diagonally-lined area in the figure, of the laser projector 30. It will be noted, however, that the four (4) IR scanners 34A, 34B, 34C and 34D scan an area less than the area accessible by the projection lasers of the projector 30. That is, the safety barrier 40 does not monitor the entire area accessible by the projection lasers of the projector 30 and the IR scanners 34A, 34B, 34C and 34D monitor less than all of the area of the projection cone 42 for an intrusion.

Further, it will be noted that the region inside of the invisible barrier 40 is not necessarily directly monitored. However, it will be observed that it is very unlikely, and perhaps virtually impossible, for a person or other foreign object to enter into the harmful region of the projector 30 without passing through one or more of the predefined monitored regions of the IR scanners 34A, 34B, 34C and 34D. Again, when an intrusion of the unobtrusive barrier 40 is detected, the laser projector 30 may switch to one of a number of safe operating modes as explained above. It will be noted that the intersection 38 is within the laser accessible region 42 and is the furthermost point of the invisible barrier 40 from the projection lens 36.

Another embodiment of the present disclosure may include three or more IR scanners forming a pyramid-shaped unobtrusive/invisible barrier around the hazardous region. The pyramid-shaped unobtrusive/invisible barrier may comprise three or more planar scanning fields that converge at a single point, typically above the projection lens of a laser projector. Likewise, it will be noted that the region inside of the pyramid-shaped barrier is not directly monitored. However, it is very unlikely, and perhaps virtually impossible, for a person to enter into the harmful region of the laser projector without passing through one or more of the predefined fields forming the wall of the pyramid-shaped barrier around the harmful region. Again, when an intrusion is detected, the laser projector 30 may switch to one of a number of safe operating modes as explained above.

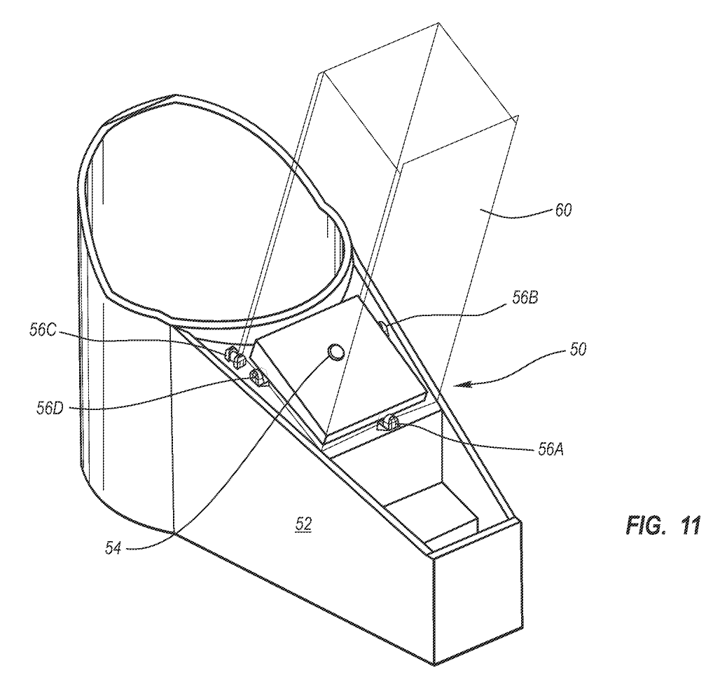

Referring now to FIGS. 11-14, there is depicted another illustrative embodiment of the present disclosure. FIG. 11 illustrates a perspective view of an exemplary laser projector 50 mounted in an enclosure 52 (as indicated above the particular shape and configuration of the enclosure is not crucial to the operation of the present system and method). The laser projector 50 includes a projection lens 54. Four (4) IR scanners 56A, 56B, 56C and 56D are disposed around the lens 54.

Still referring to FIGS. 11-14, each of the IR scanners 56A, 56B, 56C and 56D monitor a region comprising four (4) predefined monitored regions. In particular, each of the predefined monitored regions of the IR scanners 56A, 56B, 56C and 56D are substantially rectangular in shape and extend upwardly and parallel to a central axis of the projection path of the laser projector 50. The predefined monitored regions for the IR scanners 56A, 56B, 56C and 56D roughly form a four-walled unobtrusive/invisible barrier 60 around the lens 54 in the form of a “chimney.” Each of the “walls” of the “chimney” is formed by one of the predefined monitored regions, and extends upwardly from the enclosure 52 and towards the projection screen. Each of the “walls” of the chimney may be substantially parallel to an opposing “wall” and substantially perpendicular to an adjacent “wall.” It will be noted that the top end of the four-walled unobtrusive/invisible barrier 60 formed by the predefined monitored regions of the IR scanners 56A, 56B, 56C and 56D may be open or unmonitored. But again, it is unlikely that a person or object will enter from the direction of the dome screen or other surface upon which an image is projected.

It will be understood that the monitored regions of the IR scanners 56A, 56B, 56C and 56D may extend to a height greater than the harmful region of the laser projector 50, but not all of the way to the surface upon the image is projected, such as the dome. Alternatively, the height of the monitored region formed from the four (4) monitored regions may only extend to that height necessary to ensure protection from harmful exposure to laser radiation.

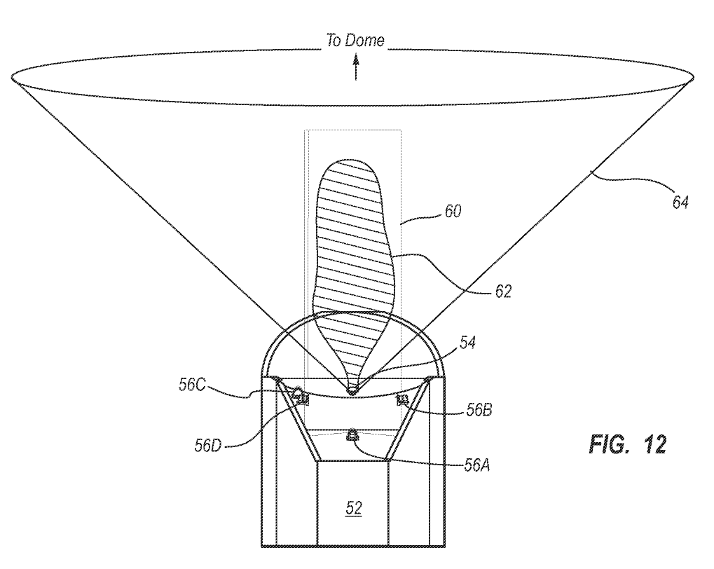

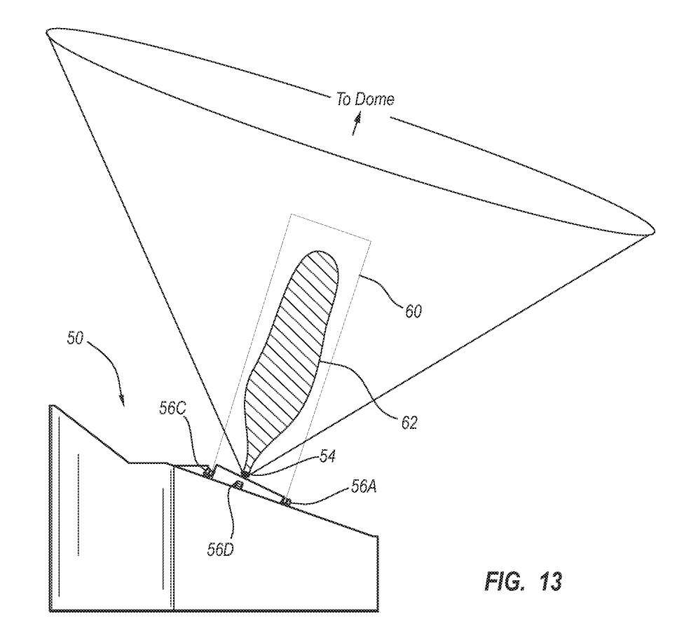

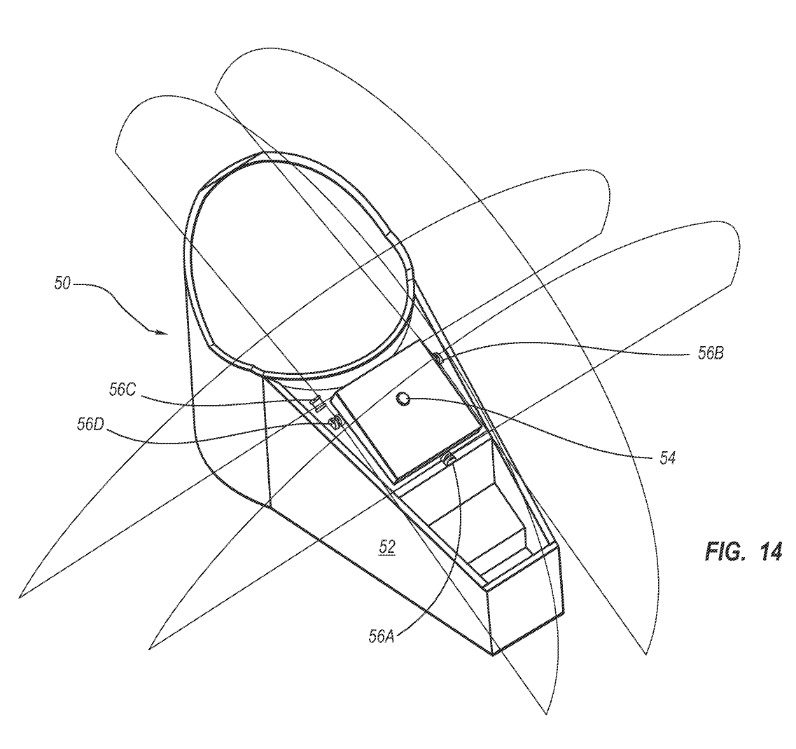

As mentioned, the monitored regions of the IR scanners 56A, 56B, 56C and 56D may roughly form a chimney shape with an unmonitored interior. Again, it will be understood that the laser accessible region (taking the form of a cone—see FIGS. 12-13) may be larger than the region monitored by the IR scanners 56A, 56B, 56C and 56D. In fact, it is entirely possible, and intentional, that a person is able to come into direct contact with laser light from the projection system 50 without triggering a switch to safe mode. When any of the IR scanners 56A, 56B, 56C and 56D detect an intrusion into a monitored region, however, the laser projector 50 may immediately and automatically switch to one of the safe operating modes as previously described.

Referring now to FIGS. 11 and 12, where like reference numerals depict like components, a projection cone 64 from the lens 54 is shown in relation to the unobtrusive/invisible barrier 60. In particular, the predefined monitored regions of the four (4) IR scanners 34A, 34B, 34C and 34D completely enclose a harmful region 62, indicated by the diagonally lined area, of the laser projector 50. It will be noted, however, that the four (4) IR scanners 56A, 56B, 56C and 56D scan an area less than the area accessible by the projection lasers of the projector 50. That is, the barrier 60 does not monitor the entire area accessible by the projection lasers of the projector 50 and the IR scanners 56A, 56B, 56C and 56D monitor less than all of the area of the projection cone 64 for an intrusion.

Further, it will be noted that the region inside of the invisible barrier 60 is not necessarily directly monitored. However, it will be observed that it is very unlikely, and perhaps virtually impossible, for a person or other object to enter into the harmful region 62 of the projector 50 without passing through one or more of the predefined monitored regions of the IR scanners 56A, 56B, 56C and 56D. Again, when an intrusion of barrier 60 is detected, the laser projector 50 may switch to one of a number of safe operating modes as explained above.

FIG. 14 illustrates the full scanning ranges of the IR scanners 56A, 56B, 56C and 56D in relation to the laser projector 50. As seen in FIG. 11, the full scanning ranges of the IR scanners 56A, 56B, 56C and 56D are purposely limited to only the predefined monitored regions as shown in FIGS. 11-13.

It will be noted that the barriers 40 and 60 described above define three-dimensional shapes formed by the planar regions scanned by IR scanners. These three-dimensional shapes extend into the laser accessible regions of a laser projection system, but do not encompass all of the laser accessible regions. It will be appreciated that the invisible safety barrier may take the form of any three-dimensional shape in accordance with the present disclosure. A suitable invisible barrier in accordance with the present disclosure need not completely enclose a harmful region formed by projection lasers, but may only bound the harmful region on at least three sides. Indeed, a safety barrier in accordance with the present disclosure extends into a laser accessible region for a laser projection system and bounds a harmful region in the laser accessible region on at least three sides. It will be further appreciated that a safety barrier in accordance with the present disclosure may not monitor the entire laser accessible region for a projection laser. Instead, some of the laser accessible region may be unmonitored.

It will be noted that in the exemplary embodiments of the present disclosure described herein, that is that it is very unlike, and perhaps virtually impossible, for a person to enter the hazardous area created by the projection lasers from behind the laser projector due to the placement of the IR scanners. The enclosure or housing for the laser projector may serve as a physical barrier to prevent such an intrusion. Furthermore, other physical barriers may be utilized to prevent a person from crawling or otherwise entering the hazardous area.

The IR scanners discussed herein may take the form of programmable IR laser scanners. One suitable commercially available IR scanner can be selected from the S3000 family of Safety Laser Scanners manufactured by SICK AG, Erwin-Sick-Str. 1, D-79183 Waldkirch, Germany. Further information regarding the S3000 family of Safety Laser Scanners can be found at the following universal resource locator addresses all of which are incorporated herein by this reference in the form they exist as of May 19, 2008:

http://www.sick.com/home/factory/catalogues/safety/espe
/laserscanner/en.html
http://www.sick.com/home/factory/catalogues/safety/espe
/laserscanner/s3000/en.html
http://www.sick.com/home/factory/catalogues/safety/espe
/laserscanner/s3000/s3000professional/en.html
http://www.sick.com/home/factory/catalogues/safety/espe
/laserscanner/s3000/s3000advanced/en.html
http://www.sick.com/home/factory/catalogues/safety/espe
/laserscanner/s3000/s3000standard/en.html
http://www.sick.com/home/factory/catalogues/safety/espe
/laserscanner/s3000/s3000remote/en.html
http://www.sick.com/home/factory/catalogues/safety/espe
/laserscanner/s3000/s3000professionalcms/en.html
http://www.sick.com/home/factory/catalogues/safety/espe
/laserscanner/s30000/en.html
http://www.mysick.com/saqqara/view.aspx?id=IM0012598

It will be appreciated that scanners other than the IR scanners disclosed herein may be used in accordance with the present invention and that any number of different devices, now know or know in the future, used to detect the presence of an object within a predefined field can also be used within the scope of the present invention. In particular, such scanner or detectors may operate using any number of different wavelengths of energy, or any combinations thereof, including ultrasonic energy.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A safety system for use with an image projection system to prevent exposure of foreign objects to hazardous optical radiation, said safety system comprising:
a plurality of light sources, wherein light produced by the light sources is relatively imperceptible by a human, each of said light sources scanning a predetermined region; and
at least one sensor for detecting reflected light originating from said plurality of light sources;
wherein said predetermined regions scanned by said light sources define an unobtrusive barrier for detecting the presence of foreign objects.

2. The safety system of claim 1, wherein said light sources are disposed proximate a projection lens of said image projection system.

3. The safety system of claim 1, wherein said image projection system comprises a laser image projection system.

4. The safety system of claim 1, wherein foreign object is a human being.

5. The safety system of claim 1, wherein the light produced by the light sources which is relatively imperceptible by a human is light in the infrared region of the electromagnetic spectrum.

6. The safety system of claim 1, wherein said light sources produce invisible light.

7. The safety system of claim 1, wherein said unobtrusive barrier extends adjacent to, but does not intersect with, a laser accessible region produced by said image projection system.

8. The safety system of claim 1, wherein said unobtrusive barrier extends into a laser accessible region of said image projection system.

9. The safety system of claim 1, wherein said unobtrusive barrier comprises a first planar region and a second planar region.

10. The safety system of claim 9, wherein said first and second planar regions are parallel.

11. The safety system of claim 9, wherein said first and second planar regions are non-parallel.

12. The safety system of claim 11, wherein said first and second planar regions intersect inside of a laser accessible region for said image projection system.

13. The safety system of claim 12, wherein said intersection of the first and second planar regions inside of the laser accessible region defines a furthest most portion of the unobtrusive barrier from a projection lens of the image projection system.

14. The safety system of claim 13, wherein said image projection system comprises a laser projection system.

15. The safety system of claim 1, wherein said unobtrusive barrier is wedge-shaped.

16. The safety system of claim 1, wherein said unobtrusive barrier is chimney-shaped.

17. The safety system of claim 1, wherein said unobtrusive barrier comprises a three-dimensional shape.

18. The safety system of claim 17, wherein said three-dimensional shape extends into a laser accessible region for said image projection system.

19. The safety system of claim 1, wherein said unobtrusive barrier extends into a laser accessible region for said image projection system and bounds a harmful region in the laser accessible region on at least three sides.

20. The safety system of claim 19, wherein said harmful region is smaller than the laser accessible region for said laser projection system.

21. The safety system of claim 1, wherein said unobtrusive barrier comprises at least four planar regions.

22. The safety system of claim 1, further comprising a control unit, wherein said control unit renders light from the image projection system to a safe level in response to a warning signal from said sensor.

23. The safety system of claim 1, wherein said unobtrusive barrier extends adjacent to a laser accessible region of said image projection system.

24. The safety system of claim 1, wherein said plurality of relatively imperceptible light sources are infrared lasers.

25. A laser projection system comprising:
at least one projection laser;
a control unit;
a plurality of invisible light sources, each of said invisible light sources scanning a planar region;
at least one sensor, the at least one sensor generating a warning signal in response to a stimulus received from one of the planar regions;
wherein said planar regions scanned by said invisible light sources define an invisible barrier for detecting foreign objects; and
wherein said control unit renders light from the projection laser to a safe level in response to the warning signal.

26. The laser projection system of claim 25, wherein said plurality of invisible light sources are disposed proximate a projection lens.

27. The laser projection system of claim 25, wherein said invisible barrier extends adjacent to, but does not intersect with, a laser accessible region of said at least one projection laser.

28. The laser projection system of claim 25, wherein said invisible barrier extends into a laser accessible region of said at least one projection laser.

29. The laser projection system of claim 25, wherein said invisible barrier comprises a first planar region and a second planar region.

30. The laser projection system of claim 29, wherein said first and second planar regions are parallel.

31. The laser projection system of claim 29, wherein said first and second planar regions are non-parallel.

32. The laser projection system of claim 31, wherein said first and second planar regions intersect inside of a laser accessible region of said at least one projection laser.

33. The safety system of claim 32, wherein said intersection of the first and second planar regions inside of the laser accessible region defines a furthest most portion of the invisible barrier from a projection lens.

34. The laser projection system of claim 25, wherein said invisible barrier is wedge-shaped.

35. The laser projection system of claim 25, wherein said invisible barrier is chimney-shaped.

36. The laser projection system of claim 25, wherein said invisible barrier comprises a three-dimensional shape.

37. The laser projection system of claim 36, wherein said three-dimensional shape extends into a laser accessible region for said at least one projection laser.

38. The laser projection system of claim 25, wherein said invisible barrier bounds a region in a laser accessible region for said at least one projection laser on at least three sides.

39. The laser projection system of claim 38, wherein said bounded region is smaller than the laser accessible region for said laser projection system.

40. The laser projection system of claim 25, wherein said invisible barrier comprises at least four planar regions.

41. The laser projection system of claim 25, wherein said invisible barrier extends adjacent to a laser accessible region of said at least one projection laser.

42. The laser projection system of claim 25, wherein said plurality of invisible light sources comprises infrared lasers.

43. A method for preventing injury from a laser projection system, said laser projection system comprising a lens for projecting laser light through a laser accessible region, the method comprising the steps of:
defining an unobtrusive barrier using a plurality of planar regions;
scanning the plurality of planar regions using at least one relatively imperceptible light source;
monitoring the planar regions for light reflected off of a foreign object; and
rendering the laser light of the laser projection system to a safe level in response to a foreign object detected in one of the planar regions.

44. The method of claim 43, wherein said at least one light source is disposed proximate the projection lens.

45. The method of claim 43, wherein said unobtrusive barrier extends adjacent to, but does not intersect with, the laser accessible region.

46. The method of claim 43, wherein said unobtrusive barrier extends into the laser accessible region.

47. The method of claim 43, wherein said unobtrusive barrier comprises a first planar region and a second planar region.

48. The method of claim 47, wherein said first and second planar regions are parallel.

49. The method of claim 47, wherein said first and second planar regions are non-parallel.

50. The method of claim 49, wherein said first and second planar regions intersect inside of the laser accessible region.

51. The safety system of claim 50, wherein said intersection of the first and second planar regions inside of the laser accessible region defines a furthest most portion of the unobtrusive barrier from the projection lens.

52. The method of claim 43, wherein said unobtrusive barrier is wedge-shaped.

53. The method of claim 43, wherein said unobtrusive barrier is chimney-shaped.

54. The method of claim 43, wherein said unobtrusive barrier comprises a three-dimensional shape.

55. The method of claim 54, wherein said three-dimensional shape extends into the laser accessible region.

56. The method of claim 43, wherein said unobtrusive barrier bounds a region in the laser accessible region on at least three sides.

57. The method of claim 56, wherein said bounded region is smaller than the laser accessible region.

58. The method of claim 43, wherein said unobtrusive barrier comprises at least four planar regions.

59. The method of claim 43, wherein said unobtrusive barrier extends adjacent to the laser accessible region.

60. The method of claim 43, wherein said at least one light source comprises an infrared laser.

61. The method of claim 43, wherein said at least one light source comprises an invisible light source.

62. The method of claim 43, wherein the step of defining an unobtrusive barrier comprises the step of defining an invisible barrier.

63. The method of claim 43, wherein the step of scanning the plurality of planar regions using at least one relatively imperceptible light source comprises the step of scanning the plurality of planar regions using at least one infrared light source.

64. The method of claim 63, wherein the step of monitoring the planar regions for light reflected off of a foreign object comprises the step of monitoring the planar regions for infrared light reflected off of a foreign object.

65. The method of claim 43, wherein the step of monitoring the planar regions for light reflected off of a foreign object comprises the step of monitoring the planar regions for light reflected off of a human being.

66. The method of claim 43, wherein the step of rendering the laser light of the laser projection system to a safe level comprises the step of reducing the power of the laser light of the laser projection system.

67. The method of claim 43, wherein the step of rendering the laser light of the laser projection system to a safe level comprises the step of redirecting the laser light of the laser projection system to a safe region.
